(19) United States
(12) Patent Application Publication
(10) Pub. No.: US 2025/0245758 A1
(43) Pub. Date: Jul. 31, 2025

(54) COMPREHENSIVE WEIGHTING HEALTH EVALUATION METHOD AND SYSTEM FOR TOP COVER DRAINAGE SYSTEM OF HYDROELECTRIC GENERATING SET

(71) Applicant: CHINA YANGTZE POWER CO., LTD, Wuhan (CN)

(72) Inventors: Gang REN, Wuhan (CN); Ge ZHANG, Wuhan (CN); Long XU, Wuhan (CN); Hui ZHANG, Wuhan (CN); Mingming YU, Wuhan (CN); Jiqi DING, Wuhan (CN); Ling GAO, Wuhan (CN); Xingyu MING, Wuhan (CN); Chao LIU, Wuhan (CN); Zhexuan MA, Wuhan (CN); Zhihuai XIAO, Wuhan (CN)

(73) Assignee: CHINA YANGTZE POWER CO., LTD, Wuhan, HB (CN)

(21) Appl. No.: 18/854,982

(22) PCT Filed: Mar. 6, 2023
(86) PCT No.: PCT/CN2023/079834

§ 371 Date: Oct. 8, 2024

(30) Foreign Application Priority Data
Apr. 20, 2022 (CN) 202210417115.5

(51) Int. Cl. G06Q 50/06; G06F 17/16

(52) U.S. Cl. CPC G06Q 50/06; G06F 17/16

(57) ABSTRACT

The present invention reveals a comprehensive health evaluation method and system for the top cover drainage system of a hydroelectric generating set. It analyzes health evaluation factors at multiple levels, processing the drainage system into a component evaluation set and a state variable evaluation set. A combined weighting method, incorporating both initial weight and objective weighting methods, is used for comprehensive weighting across the levels. Standard requirements and scoring criteria are established, enabling sequential calculation of scores from state variables to components, then to the top cover drainage system, progressing from low to high levels. This process evaluates the health degrees at each level, resulting in a comprehensive and reliable health evaluation outcome. Consequently, it effectively addresses technical issues in prior art, such as limitations in health evaluation methods and the low reliability and universality of evaluation results.

### TECHNICAL FIELD

The present invention relates to the field of power generation technology, and particularly relates to a comprehensive weighting health evaluation method and system for a top cover drainage system of a hydroelectric generating set.

### BACKGROUND OF THE INVENTION

As a core part of the efficiency and economy of water conservancy hubs, the installed capacity of hydroelectric generating sets in recent years has been growing rapidly, and its proportion in the national power grid is also growing, and is developing towards the direction of large size, integration and high power. With the increasing complexity of structures of the hydroelectric generating sets, the operational stability of equipment on the security of power stations and interconnected power grids is also increasingly large, and is very important for health state monitoring, evaluation, and maintenance thereof. There is an urgent need to grasp the true health state of the unit equipment in real time, allowing for the scientific and rational formulation of unit operation and maintenance strategies and the implementation of intelligent operation and maintenance management plans, thereby enhancing the stability and efficiency of the hydroelectric generating sets from multiple angles.

As one of the important auxiliary systems of a hydroelectric generating set, the operational reliability and safety of a top cover drainage system are crucial for the safe operation of the entire hydroelectric generating set. Currently, comprehensive health evaluation methods for the top cover drainage system of the hydroelectric generating set are relatively scarce and limited.

### SUMMARY OF THE INVENTION

The purpose of the present invention is to overcome the above deficiencies and provide a comprehensive weighting health evaluation method and system for a top cover drainage system of a hydroelectric generating set, so as to solve the technical problems of limited health evaluation methods and low reliability and universality of evaluation results in the prior art.

The technical solution adopted by the present invention to solve the above technical problems is:

A comprehensive weighting health evaluation method for a top cover drainage system of a hydroelectric generating set, comprising the following steps:
step 1: acquiring initial weights of components;
step 2: acquiring a comprehensive weight of state variables;
step 3: establishing standard requirements and scoring criteria for the top cover drainage system, the components and the state variables;
step 4: obtaining corresponding scores of the state variables based on monitoring point data of monitored variables from equipment;
step 5: obtaining corresponding scores of the components based on the calculated scores of the state variables according to the comprehensive weight of the state variables;
step 6: obtaining a corresponding score of the top cover drainage system based on the calculated scores of the components according to a comprehensive weight of the components; and
step 7: obtaining a final health evaluation result based on the score of the top cover drainage system according to the scoring criteria.

Furthermore, acquiring the initial weights of the components in step 1 comprises the following steps:
step 1.1, dividing different components of the top cover drainage system of the hydroelectric generating set according to a first preset rule, and establishing a component-level evaluation set, wherein the first preset rule is the National Standard GB/T 11805-2019;
step 1.2, scoring the component-level evaluation set to form a direct influence matrix;
step 1.3, normalizing the direct influence matrix to obtain a normalized direct influence matrix; and
step 1.4, calculating the normalized direct influence matrix to obtain a comprehensive influence matrix, and obtaining the corresponding initial weights of the components.

Furthermore, step 1.3 specifically comprises the following steps:
normalizing the direct influence matrix according to a first preset formula and a second preset formula to obtain the normalized direct influence matrix;

$$the first preset formula being {H}_{ax var} = max ( {\sum }_{j = 1}^{n} {a}_{ij} ) ;$$

$$the second preset formula being N = {( \frac{{a}_{ij}}{{H}_{arvar}} )}_{n \times n} ;$$

wherein in the formulas, H_{ax var} represents the direct influence matrix, aᵢⱼ represents the components or the state variables in a scenario set, and N represents the normalized direct influence matrix.

Furthermore, step 1.4 specifically comprises the following steps:
superimposing indirect influences of elements in the normalized influence matrix through a third preset formula to obtain the comprehensive influence matrix;

$$a third preset formula being T = {N ( I - N )}^{- 1} ;$$

wherein in the formula, N represents the normalized direct influence matrix, and T represents the comprehensive influence matrix;
according to a fourth preset formula, a fifth preset formula and a sixth preset formula, respectively obtaining influence degrees, influenced degrees and central degrees of influence factors, and calculating the initial weights through a seventh preset formula;

$$the fourth preset formula being {D}_{i} = {\sum }_{j = 1}^{n} {t}_{ij} , ( i = 1 , 2 , 3 , … , n ) ;$$

wherein in the formula, tᵢⱼ represents a comprehensive influence value of a corresponding element on all other elements in each row;

$$the fifth preset formula being {C}_{i} = {\sum }_{j = 1}^{n} {t}_{ji} , ( i = 1 , 2 , 3 , … , n ) ;$$

wherein in the formula, tⱼᵢ represents a comprehensive influence value of a corresponding element on all other elements in each column;

$$the sixth preset formula being {M}_{i} = {D}_{i} + {C}_{i} ;$$

wherein in the formula, Dᵢ represents the influence degree, and Cᵢ represents the influenced degree;

$$the seventh preset formula being {ω}_{i} = \frac{{M}_{i}}{{\sum }_{i = 1}^{n} {M}_{i}} ;$$

wherein in the formula, Mᵢ represents the central degree.

Furthermore, acquiring the comprehensive weight of the state variables in step 2 comprises the following steps:
step 2.1, dividing different state variables of components in the component-level evaluation set according to a second preset rule, and establishing a state variable-level evaluation set, wherein the second preset rule is the National Standard GB/T 28570-2012;
step 2.2, scoring the state variable-level evaluation set to form a direct influence matrix;
step 2.3, normalizing the direct influence matrix to obtain a normalized direct influence matrix;
step 2.4, calculating the normalized direct influence matrix to obtain a comprehensive influence matrix, and obtaining corresponding initial weights of the state variables;
step 2.5, determining corresponding objective weights of the state variables of the components based on an anti-entropy weighting method; and
step 2.6, performing a coupling calculation to obtain the comprehensive weight according to the initial weights and the determined objective weights of the state variables.

Furthermore, step 3 comprises the following steps:
step 3.1, determining evaluation contents of the components in an evaluation scope of the top cover drainage system, wherein the evaluation contents are related to the state variables, and the state variables of the components need to be determined;
step 3.2, determining score deduction criteria for the state variables, which include standard requirements and scoring standards, and sequentially deducting corresponding scores that meet conditions to obtain a final score, wherein a unified score range for the state variables is 0-100, with an initial score of 100, and the score deduction conditions are related to target variables of the state variables; and
step 3.3, determining the scoring criteria for the top cover drainage system.

Furthermore, step 4 comprises the following steps:
step 4.1, obtaining the scores of the state variables according to an eighth preset formula;

$$the seventh preset formula being U = 100 - P . ;$$

wherein in the formula, U represents the scores of the state variables, and P represents deducted scores of the state variables.

Furthermore, step 5 comprises the following steps:
step 5.1, obtaining the scores of the components according to a ninth preset formula;

$$the ninth preset formula being Q = {\sum }_{1}^{n} {θ}_{j} {U}_{i} ( i = 1 , 2 , 3 , … , n ) ;$$

wherein in the formula, Q represents the scores of the components, θⱼ represents the comprehensive weight of the state variables; and Uᵢ represents the scores of the state variables.

Furthermore, step 6 comprises the following steps:
step 6.1, obtaining the score of the top cover drainage system according to a tenth preset formula;

$$the tenth preset formula being R = {\sum }_{1}^{n} {ω}_{i} {Q}_{i} ( i = 1 , 2 , 3 , … , n ) ;$$

wherein in the formula, R represents the score of the top cover drainage system, ωᵢ represents the initial weights of the components; and Qᵢ represents the scores of the components.

In addition, the present invention also discloses a comprehensive weighting health evaluation system for a top cover drainage system of a hydroelectric generating set, comprising: an initial weighting module, a comprehensive weighting module, a criterion establishment module, a state variable scoring module, a component scoring module, a system scoring module and a health evaluation module;
the initial weighting module, configured to acquire initial weights of components;
the comprehensive weighting module configured to acquire a comprehensive weight of state variables;
the criterion establishment module, configured to establish standard requirements and scoring criteria for the top cover drainage system, the components and the state variables;
the state variable scoring module, configured to acquire scores of the state variables through monitoring point data and the scoring criteria for the state variables;
the component scoring module, configured to acquire scores of the components through the comprehensive weight of the state variables and the scores of the state variables;
the system scoring module, configured to acquire a score of the top cover drainage system through the initial weights of the components and the scores of the components; and
the health evaluation module, configured to acquire a final health evaluation result through the score of the top cover drainage system.

The beneficial effects of the present invention are as follows:
the present invention analyzes health evaluation factors of the top cover drainage system of the hydroelectric generating set at multiple levels, and effectively solves the technical problems in the prior art, such as limitations of health evaluation methods, and low reliability and universality of evaluation results, by processing the top cover drainage system of the hydroelectric generating set into a component evaluation set and a state variable evaluation set; performing comprehensive weighting on levels using a combined weighting method that includes an initial weight method (AHP) and an objective weighting method; establishing standard requirements and scoring criteria of the levels; and calculating scores of the levels sequentially from state variables to components, then from the components to the top cover drainage system, and from a low level to a high level, and evaluating health degrees of the levels to obtain a comprehensive and reliable health evaluation result.

### BRIEF DESCRIPTION OF DRAWINGS

FIG. 1 is a flow diagram of a first embodiment of a comprehensive weighting health evaluation method for a top cover drainage system of a hydroelectric generating set according to the present invention;

FIG. 2 is a flow diagram of step 1 of the first embodiment of the comprehensive weighting health evaluation method for the top cover drainage system of the hydroelectric generating set according to the present invention;

FIG. 3 is a flow diagram of step 2 of the first embodiment of the comprehensive weighting health evaluation method for the top cover drainage system of the hydroelectric generating set according to the present invention; and

FIG. 4 is a schematic diagram of modules of the first embodiment of the comprehensive weighting health evaluation system for the top cover drainage system of the hydroelectric generating set according to the present invention.

### DETAILED DESCRIPTION OF THE INVENTION

The present invention will be described in further detail below in conjunction with the accompanying drawings and the specific embodiments.

A comprehensive weighting health evaluation method for a top cover drainage system of a hydroelectric generating set, comprising the following steps:
step 1: acquiring initial weights of components;
step 2: acquiring a comprehensive weight of state variables;
step 3: establishing standard requirements and scoring criteria for the top cover drainage system, the components and the state variables;
step 4: obtaining corresponding scores of the state variables based on monitoring point data of monitored variables from equipment;
step 5: obtaining corresponding scores of the components based on the calculated scores of the state variables according to the comprehensive weight of the state variables;
step 6: obtaining a corresponding score of the top cover drainage system based on the calculated scores of the components according to a comprehensive weight of the components; and
step 7: obtaining a final health evaluation result based on the score of the top cover drainage system according to the scoring criteria.

Furthermore, acquiring the initial weights of the components in step 1 comprises the following steps:
step 1.1, dividing different components of the top cover drainage system of the hydroelectric generating set according to a first preset rule, and establishing a component-level evaluation set, wherein the first preset rule is the National Standard GB/T 11805-2019;
step 1.2, scoring the component-level evaluation set to form a direct influence matrix;
step 1.3, normalizing the direct influence matrix to obtain a normalized direct influence matrix; and
step 1.4, calculating the normalized direct influence matrix to obtain a comprehensive influence matrix, and obtaining the corresponding initial weights of the components.

Furthermore, step 1.3 specifically comprises the following steps:
normalizing the direct influence matrix according to a first preset formula and a second preset formula to obtain the normalized direct influence matrix;

$$the first preset formula being {H}_{ax var} = max ( {\sum }_{j = 1}^{n} {a}_{ij} ) ;$$

$$the second preset formula being N = {( \frac{{a}_{ij}}{{H}_{arvar}} )}_{n \times n} ;$$

wherein in the formulas, H_{ax var} represents the direct influence matrix, aᵢⱼ represents the components or the state variables in a scenario set, and N represents the normalized direct influence matrix.

Furthermore, step 1.4 specifically comprises the following steps:
superimposing indirect influences of elements in the normalized influence matrix through a third preset formula to obtain the comprehensive influence matrix;

$$a third preset formula being T = {N ( I - N )}^{- 1} ;$$

wherein in the formula, N represents the normalized direct influence matrix, and T represents the comprehensive influence matrix;
according to a fourth preset formula, a fifth preset formula and a sixth preset formula, respectively obtaining influence degrees, influenced degrees and central degrees of influence factors, and calculating the initial weights through a seventh preset formula;

$$the fourth preset formula being {D}_{i} = {\sum }_{j = 1}^{n} {t}_{ij} , ( i = 1 , 2 , 3 , … , n ) ;$$

wherein in the formula, tᵢⱼ represents a comprehensive influence value of a corresponding element on all other elements in each row;

$$the fifth preset formula being {C}_{i} = {\sum }_{j = 1}^{n} {t}_{ji} , ( i = 1 , 2 , 3 , … , n ) ;$$

wherein in the formula, tⱼᵢ represents a comprehensive influence value of a corresponding element on all other elements in each column;

$$the sixth preset formula being {M}_{i} = {D}_{i} + {C}_{i} ;$$

wherein in the formula, Dᵢ represents the influence degree, and Cᵢ represents the influenced degree;

$$the seventh preset formula being {ω}_{i} = \frac{{M}_{i}}{{\sum }_{i = 1}^{n} {M}_{i}} ;$$

wherein in the formula, Mᵢ represents the central degree.

Furthermore, acquiring the comprehensive weight of the state variables in step 2 comprises the following steps:
step 2.1, dividing different state variables of components in the component-level evaluation set according to a second preset rule, and establishing a state variable-level evaluation set, wherein the second preset rule is the National Standard GB/T 28570-2012;
step 2.2, scoring the state variable-level evaluation set to form a direct influence matrix;
step 2.3, normalizing the direct influence matrix to obtain a normalized direct influence matrix;
step 2.4, calculating the normalized direct influence matrix to obtain a comprehensive influence matrix, and obtaining corresponding initial weights of the state variables;
step 2.5, determining corresponding objective weights of the state variables of the components based on an anti-entropy weighting method; and
step 2.6, performing a coupling calculation to obtain the comprehensive weight according to the initial weights and the determined objective weights of the state variables.

Furthermore, step 3 comprises the following steps:
step 3.1, determining evaluation contents of the components in an evaluation scope of the top cover drainage system, wherein the evaluation contents are related to the state variables, and the state variables of the components need to be determined;
step 3.2, determining score deduction criteria for the state variables, which include standard requirements and scoring standards, and sequentially deducting corresponding scores that meet conditions to obtain a final score, wherein a unified score range for the state variables is 0-100, with an initial score of 100, and the score deduction conditions are related to target variables of the state variables; and step 3.3, determining the scoring criteria for the top cover drainage system.

Furthermore, step 4 comprises the following steps:
step 4.1, obtaining the scores of the state variables according to an eighth preset formula;

$$the seventh preset formula being U = 100 - P ;$$

wherein in the formula, U represents the scores of the state variables, and P represents deducted scores of the state variables.

Furthermore, step 5 comprises the following steps:
step 5.1, obtaining the scores of the components according to a ninth preset formula;

$$the ninth preset formula being Q = {\sum }_{1}^{n} {θ}_{j} {U}_{i} ( i = 1 , 2 , 3 , ... , n ) ;$$

wherein in the formula, Q represents the scores of the components, θⱼ represents the comprehensive weight of the state variables; and Uᵢ represents the scores of the state variables.

Furthermore, step 6 comprises the following steps:
step 6.1, obtaining the score of the top cover drainage system according to a tenth preset formula;

$$the tenth preset formula being R = {\sum }_{1}^{n} {ω}_{i} {Q}_{i} ( i = 1 , 2 , 3 , ... , n ) ;$$

wherein in the formula, R represents the score of the top cover drainage system, ωᵢ represents the initial weights of the components; and Qᵢ represents the scores of the components.

In addition, the present invention also discloses a comprehensive weighting health evaluation system for a top cover drainage system of a hydroelectric generating set, comprising: an initial weighting module 10, a comprehensive weighting module 20, a criterion establishment module 30, a state variable scoring module 40, a component scoring module 50, a system scoring module 60 and a health evaluation module 70;
the initial weighting module 10, configured to acquire initial weights of components;
the comprehensive weighting module 20 configured to acquire a comprehensive weight of state variables;
the criterion establishment module 30, configured to establish standard requirements and scoring criteria for the top cover drainage system, the components and the state variables;
the state variable scoring module 40, configured to acquire scores of the state variables through monitoring point data and the scoring criteria for the state variables;
the component scoring module 50, configured to acquire scores of the components through the comprehensive weight of the state variables and the scores of the state variables;
the system scoring module 60, configured to acquire a score of the top cover drainage system through the initial weights of the components and the scores of the components;
and the health evaluation module 70, configured to acquire a final health evaluation result through the score of the top cover drainage system.

The following is a description of the specific embodiments:

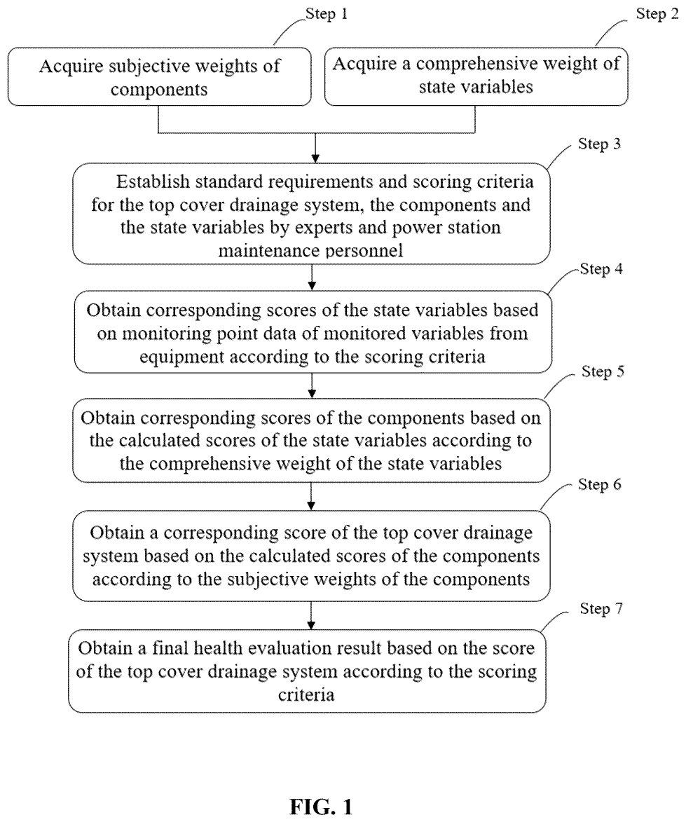

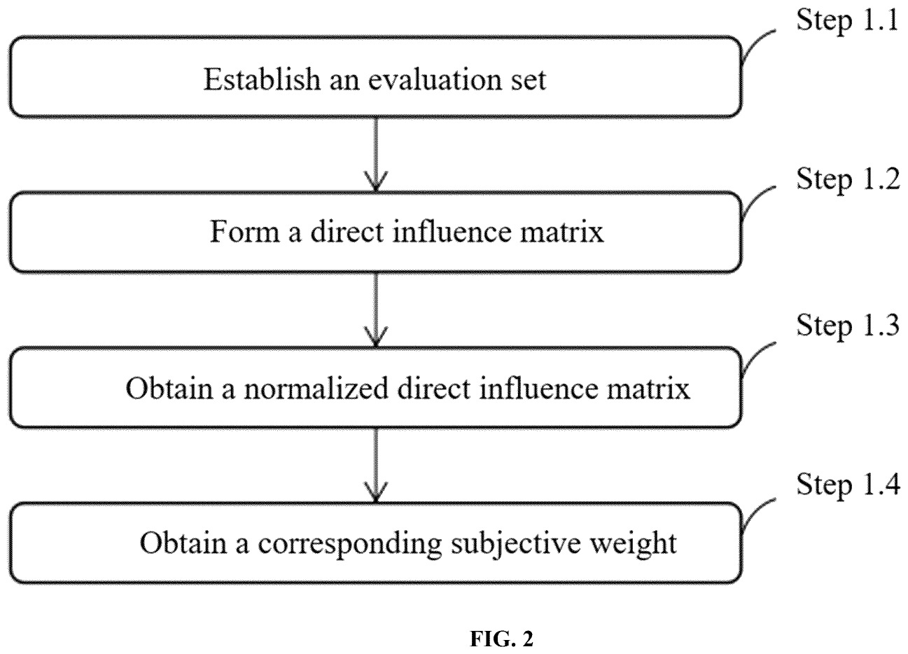

As shown in FIG. 1, the steps of a comprehensive weighting health evaluation method for a top cover drainage system of a hydroelectric generating set are as follows:
step 1, acquiring initial weights of components;
step 1.1, dividing different components of the top cover drainage system of the hydroelectric generating set according to a first preset rule, and establishing a component-level evaluation set,
wherein according to the National Standard GB/T 11805-2019, the top cover drainage system is categorized into a water pump, a power supply, a PLC control component and a liquid level measurement component.
step 1.2, scoring the component-level evaluation set to form a direct influence matrix;

TABLE 1
State Variable Scale Table

| Rating | Natural language |
|---|---|
| Scale | description |
| 1 | Slightly Important |
| 2 | Somewhat Important |
| 3 | Moderately Important |
| 4 | Significantly Important |
| 5 | Extremely Important |

Using a 1-5 rating scale and based on the scoring ratings in Table 1, the importance degrees of four components are evaluated to obtain the direct influence matrix. Taking a conventional top cover drainage system of a hydroelectric generating set as an example, this invention involves four components: water pump A, power supply B, PLC control component C, and liquid level measurement component D. The obtained direct influence matrix H_{4×4} is as follows:

$${H}_{4 \times 4} = [ \begin{matrix}{a}_{A - A} & {a}_{A - B} & {a}_{A - C} & {a}_{A - D} \\ {a}_{B - A} & {a}_{B - B} & {a}_{B - D} & {a}_{B - D} \\ {a}_{C - A} & {a}_{C - B} & {a}_{C - C} & {a}_{C - D} \\ {a}_{D - A} & {a}_{D - B} & {a}_{D - C} & {a}_{D - D}\end{matrix} ] \qquad ( 1 )$$

wherein a_{A-B} is a comparison result of the importance degrees of the water pump and the power supply.
step 1.3, normalizing the direct influence matrix to obtain a normalized direct influence matrix;
wherein the direct influence matrixH_{n×n} is normalized according to formulas (2) and (3) to obtain the normalized direct influence matrix.

$${H}_{ax var} = max ( {\sum }_{j = 1}^{n} {a}_{ij} ) \qquad ( 2 )$$

$$N = {( \frac{{a}_{ij}}{{H}_{arvar}} )}_{n \times n} \qquad ( 3 )$$

step 1.4, calculating the normalized direct influence matrix to obtain a comprehensive influence matrix, and obtaining the corresponding initial weights of the components; and
wherein indirect influences of elements in the normalized influence matrix are superimposed through a formula (4) to obtain the comprehensive influence matrixZ_{n×n}

$$T = {N ( T - N )}^{- 1} \qquad ( 4 )$$

Influence degrees, influenced degrees and central degrees of influence factors can be derived respectively from formulas (5), (6) and (7), and the initial weights can be calculated from a formula (8).

$${D}_{i} = {\sum }_{j = 1}^{n} {t}_{ij} , ( i = 1 , 2 , 3 , ... , n ) \qquad ( 5 )$$

wherein in the formula, tᵢⱼ represents a comprehensive influence value of a corresponding element on all other elements in each row.

$${C}_{i} = {\sum }_{j = 1}^{n} {t}_{ji} , ( i = 1 , 2 , 3 , ... , n ) \qquad ( 6 )$$

wherein in the formula, tⱼᵢ represents a comprehensive influence value of a corresponding element on all other elements in each column.

$${M}_{i} = {D}_{i} + {C}_{i} \qquad ( 7 )$$

$${ω}_{i} = \frac{{M}_{i}}{{\sum }_{i = 1}^{n} {M}_{i}} \qquad ( 8 )$$

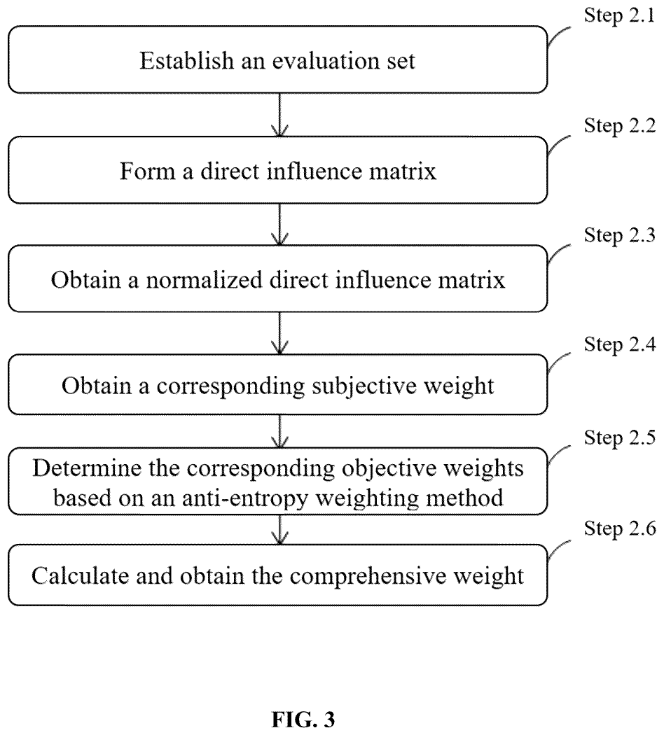

Step 2, acquiring a comprehensive weight of state variables;
wherein a traditional weight is set as an initial weight or an objective weight, which can not realize a combined weight of actual conditions and standard theories of field equipment. A comprehensive weighting method can solve the problems existing in a traditional weighting method, and the process of obtaining a comprehensive weight is shown in FIG. 3.
step 2.1, dividing different state variables of the components in the component-level evaluation set according to a second preset rule, and establishing a state variable-level evaluation set;
wherein taking a conventional water pump component as an example, according to the National Standard GB/T 28570-2012, state variables of the water pump component can be categorized into system availability rate, water pump operating state, number of water level simulation out-of-tolerance occurrences, slope calculation and efficiency, and number of abnormal actions.
step 2.2, scoring the state variable-level evaluation set to form a direct influence matrix.

TABLE 1
State Variable Scale Table

| Rating | Natural language |
|---|---|
| Scale | description |
| 1 | Slightly Important |
| 2 | Somewhat Important |
| 3 | Moderately Important |
| 4 | Significantly Important |
| 5 | Extremely Important |

Using a 1-5 rating scale and based on the scoring ratings in Table 1, the importance degrees of four components are evaluated to obtain a direct influence matrix. Taking a conventional water pump as an example, this invention involves five state variables: system availability rate A, water pump operating state B, number C of out-of-tolerance occurrences of water level simulation values, slope calculation and efficiency D, and number E of abnormal actions. The obtained direct influence matrix H5×5 is as follows:

$${H}_{5 \times 5} = [ \begin{matrix}{a}_{A - A} & {a}_{A - B} & {a}_{A - C} & {a}_{A - D} & {a}_{A - E} \\ {a}_{B - A} & {a}_{B - B} & {a}_{B - C} & {a}_{B - D} & {a}_{A - E} \\ {a}_{C - A} & {a}_{C - B} & {a}_{C - C} & {a}_{C - D} & {a}_{C - E} \\ {a}_{D - A} & {a}_{D - B} & {a}_{D - C} & {a}_{D - D} & {a}_{D - E} \\ {a}_{E - A} & {a}_{E - B} & {a}_{E - C} & {a}_{E - D} & {a}_{E - E}\end{matrix} ] \qquad ( 9 )$$

wherein a_{A-B} is a comparison result of importance degrees of the system availability rate and the water pump operating state.
step 2.3, normalizing the direct influence matrix to obtain a normalized direct influence matrix; and
wherein the direct influence matrixH_{n×n} is normalized according to formulas (2) and (3) to obtain the normalized direct influence matrix.

$${H}_{ax var} = max ( {\sum }_{j = 1}^{n} {a}_{ij} ) \qquad ( 10 )$$

$$N = {( \frac{{a}_{ij}}{{H}_{arvar}} )}_{n \times n} \qquad ( 11 )$$

step 2.4, calculating the normalized direct influence matrix to obtain a comprehensive influence matrix, and obtaining corresponding initial weights of the state variables;
wherein indirect influences of elements in the normalized influence matrix are superimposed through a formula (12) to obtain the comprehensive influence matrixZ_{n×n}.

$$T = {N ( T - N )}^{- 1} \qquad ( 12 )$$

Influence degrees, influenced degrees and central degrees of influence factors can be derived respectively from formulas (13), (14) and (15), and the initial weights can be calculated from a formula (16).

$${D}_{i} = {\sum }_{j = 1}^{n} {t}_{ij} , ( i = 1 , 2 , 3 , ... , n ) \qquad ( 13 )$$

wherein in the formula, tᵢⱼ represents a comprehensive influence value of a corresponding element on all other elements in each row.

$${C}_{i} = {\sum }_{j = 1}^{n} {t}_{ji} , ( i = 1 , 2 , 3 , ... , n ) \qquad ( 14 )$$

wherein in the formula, tⱼᵢ represents a comprehensive influence value of a corresponding element on all other elements in each column.

$${M}_{i} = {D}_{i} + {C}_{i} \qquad ( 15 )$$

wherein in the formula, Dᵢ represents the influence degree, and Cᵢ represents the influenced degree;

$${ω}_{i} = \frac{{M}_{i}}{{\sum }_{i = 1}^{n} {M}_{i}} \qquad ( 16 )$$

wherein in the formula, Mᵢ represents the central degree.
step 2.5, determining corresponding objective weights of the state variables of the components based on an anti-entropy weighting method;
wherein further, the anti-entropy weighting method in step 2.5 highlights both a main factor and other factors, and the objective weights can be obtained through formulas (17), (18) and (19).

$${b}_{i j} = \frac{{a}_{i j}}{{\sum }_{i = 1}^{m} {a}_{i j}} \qquad ( 17 )$$

$${s}_{j} = - {\sum }_{i = 1}^{m} {b}_{i j} ln ( 1 - {b}_{i j} ) \qquad ( 18 )$$

$${μ}_{j} = \frac{{s}_{j}}{{\sum }_{j = 1}^{n} {s}_{j}} \qquad ( 19 )$$

wherein in the formula, aᵢⱼ and bᵢⱼ respectively represent a standardized index value and a normalized standardized index value; sⱼand μⱼ respectively represent an anti-entropy value and an objective weight coefficient of indexes.
step 2.6, performing a coupling calculation to obtain the comprehensive weight according to the initial weights and the determined objective weights of the state variables;
wherein the comprehensive weight is obtained by coupling the initial weights and the objective weights through formulas (20) and (21), highlighting both a main factor and other factors;

$$\{ \begin{matrix}{ε}_{j} = \frac{{ω}_{j}}{{ω}_{j} + {μ}_{j}} \\ {δ}_{j} = \frac{{μ}_{j}}{{ω}_{j} + {μ}_{j}}\end{matrix} \qquad ( 20 )$$

$${θ}_{j} = \frac{( {ε}_{j} {ω}_{j} + {δ}_{j} {μ}_{j} )}{{\sum }_{j}^{n} ( {ε}_{j} {ω}_{j} + {δ}_{j} {μ}_{j} )} \qquad ( 21 )$$

wherein in the formula, εⱼ, δⱼ respectively represent coupling coefficients of subjective and objective weights of the indexes. θⱼ represents the comprehensive weight. This allows for the processing of the subjective weights before coupling the subjective weights with the objective weights, greatly reducing the influence of subjective factors on equipment evaluation.

Step 3, establishing standard requirements and scoring criteria for the top cover drainage system, the components and the state variables;

step 3.1, determining evaluation contents of the components within an evaluation scope of the top cover drainage system, wherein the evaluation contents are related to the state variables, and the state variables of the components need to be determined.

Taking a conventional top cover drainage system as an example, the evaluation scope and the evaluation contents are as shown in Table 2:

TABLE 2
Evaluation Scope and Evaluation Content of Top Cover Drainage System

| Evaluation Scope | Evaluation content |
|---|---|
| Water pump | Component life, system availability rate, water pump operating |
| | state number of water level simulation out-of-tolerance |
| | occurrences, slope calculation and efficiency, and number of |
| | abnormal actions |
| Power supply | Component life, system availability rate |
| PLC control component | Component life, system availability rate number of abnormal |
| | actions |
| Liquid-level measurement | Component life, system availability rate, number of water level |
| component | simulation out-of-tolerance occurrences |

Step 3.2, determining score deduction standards of the state variables, wherein the score deduction standards include standard requirements and scoring standards.

Taking the system availability rate as an example, the score deduction standards are as shown in Table 3:

TABLE 3
Score Deduction Standards of State Variables

| State | | |
|---|---|---|
| variable | Standard requirement | Scoring standard |
| System | Turbine auxiliary control cabinet | The system availability rate is A, and the |
| availability | PLC without faults | state is Z. A ≥ 95%, Z = Good; 90% ≤ A < |
| rate | Automatic mode of each water | 95%, Z = Attention; A < 90%, Z = |
| | pump | Abnormal. |
| | The number of available water | 1) Z = Good, the deducted score is 0 |
| | pumps is not less than 2 | Z = Attention, the deducted score is 20 |
| | An error of measured values of | 3) Z = Abnormal, the deducted score is 40 |
| | two liquid level meters is more | |
| | than 5 cm | |
| | 5) The unit is not in a | |
| | maintenance state | |

step 3.3, determining the scoring criteria;

Taking a conventional top cover drainage system as an example, the scoring criteria are as shown in Table 4:

TABLE 4
Scoring Criteria for Top Cover Drainage System

| | | 85-95 | 75-85 | 60-75 | Below 60 |
|---|---|---|---|---|---|
| Scores | 95-100 | (inclusive) | (inclusive) | (inclusive) | (inclusive) |
| State | Good | Normal | Attention | Abnormal | Significant |
| | | | | | abnormal |

Step 4, obtaining corresponding scores of the state variables based on monitoring point data of monitored variables from equipment according to the scoring criteria;
wherein the scores of the state variables can be derived from a formula (22).

$$U = 100 - P \qquad ( 22 )$$

wherein in the formula, U represents the scores of the state variables, and P represents deducted scores of the state variables.

Step 5, obtaining corresponding scores of the components based on the calculated scores of the state variables according to the comprehensive weight of the state variables;
wherein the scores of the components can be derived from a formula (23),

$$Q = {\sum }_{1}^{n} {θ}_{j} {U}_{i} ( i = 1 , 2 , 3 , … , n ) \qquad ( 23 )$$

wherein in the formula, Q represents the scores of the components, θⱼ represents the comprehensive weight of the state variables, and Uᵢ represents the scores of the state variables.

Step 6, obtaining a corresponding score of the top cover drainage system based on the calculated scores of the components according to a comprehensive weight of the components to serve as an evaluation index reflecting the health degree of the top cover drainage system based on the top cover drainage system;
wherein the score of the top cover drainage system can be derived from a formula (24);

$$R = {\sum }_{1}^{n} {ω}_{i} {Q}_{i} ( i = 1 , 2 , 3 , … , n ) \qquad ( 24 )$$

wherein in the formula, R represents the score of the top cover drainage system, wᵢ represents the initial weights of the components; and Qᵢ represents the scores of the components.

Step 7, obtaining a final health evaluation result based on the score of the top cover drainage system according to the scoring criteria.

In order to achieve the above purpose, the present embodiment further provides a storage medium, wherein the storage medium stores a comprehensive weighting health evaluation program for a top cover drainage system of a hydroelectric generating set, and when the comprehensive weighting health evaluation program for the top cover drainage system of the hydroelectric generating set is executed, the steps of the comprehensive weighting health evaluation method for the top cover drainage system of the hydroelectric generating set are implemented.

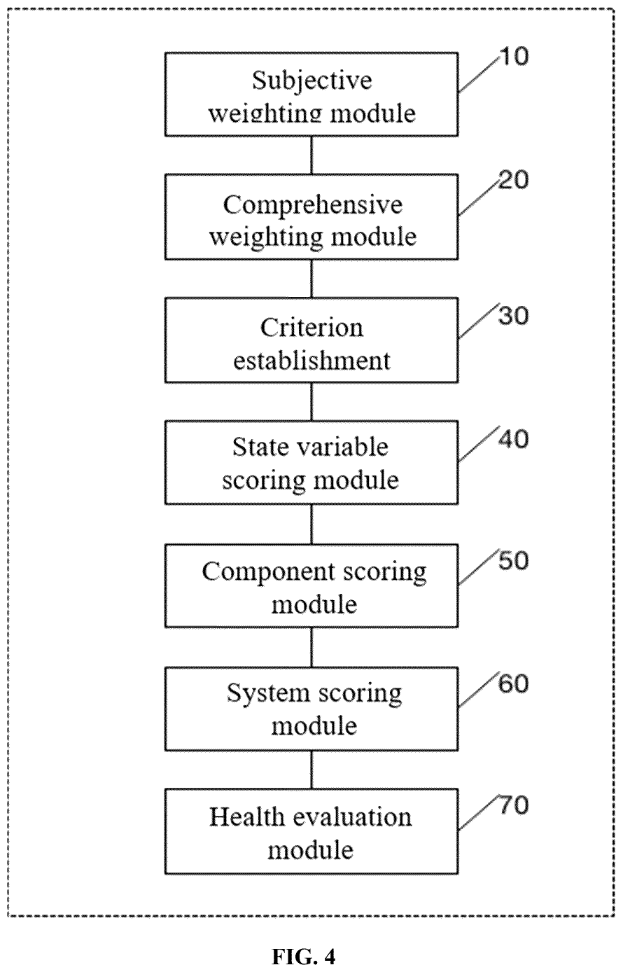

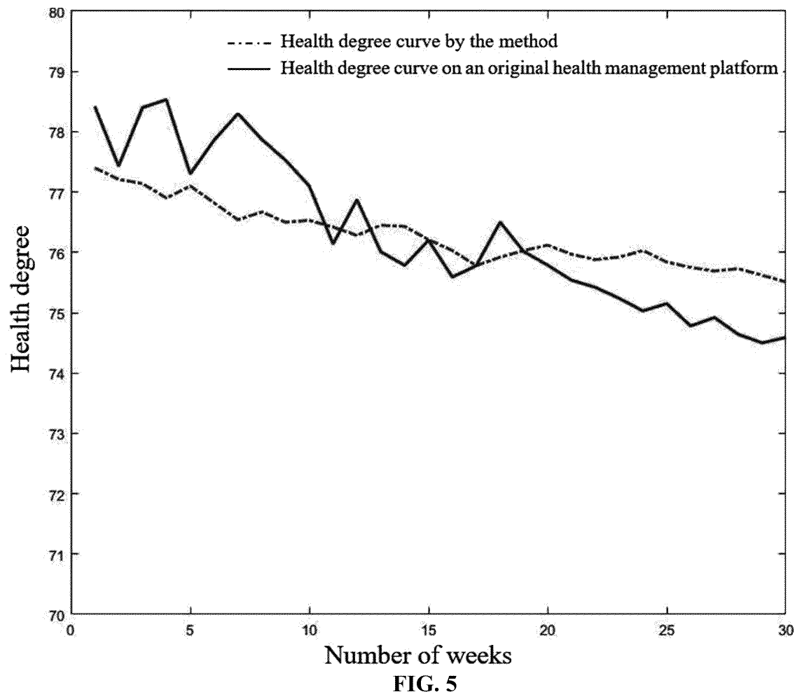

Referring to FIG. 4, in order to achieve the above purpose, the present embodiment further provides a comprehensive weighting health evaluation system for a top cover drainage system of a hydroelectric generating set. The comprehensive weighting health evaluation system for the top cover drainage system of the hydroelectric generating set includes:
an initial weighting module 10, configured to acquire initial weights of components;
a comprehensive weighting module 20, configured to acquire a comprehensive weight of state variables;
a criterion establishment module 30, configured to establish standard requirements and scoring criteria for the top cover drainage system, the components and the state variables;
a state variable scoring module 40, configured to acquire scores of the state variables through monitoring point data and the scoring criteria for the state variables;
a component scoring module 50, configured to acquire scores of the components through the comprehensive weight of the state variables and the scores of the state variables;
a system scoring module 60, configured to acquire a score of the top cover drainage system through the initial weights of the components and the scores of the components; and
a health evaluation module 70, configured to acquire a final health evaluation result through the score of the top cover drainage system.

In addition, we study the actual on-site state monitoring data of Unit 1 of a hydropower station to verify the effectiveness of the comprehensive weighting health evaluation method of the top cover drainage system of the hydroelectric generating set of the present invention. The data of the hydroelectric generating set from Jun. 21, 2021 to Jul. 21, 2021 was selected as the object of study. The specific analysis steps are:

### 1) Acquiring Initial Weights of Components

Establishing an industry expert evaluation group to evaluate relative importance degrees of components at each level of a hierarchical analysis system for the top cover drainage system, and using an AHP weighting method to calculate their weights, wherein the results of the initial weights of the component levels are shown in Table 5.

TABLE 5
Statistics of Initial Weight Calculation Results for Component Levels

| Component level (B) | Initial weight |
|---|---|
| B1 Water pump | 53.896% |
| B2 PLC control component | 16.378% |
| B3 Liquid level measurement component | 16.378% |

### 2) Acquire a Comprehensive Weight of State Variables

By combining historical data of the unit, objective weights of the state variables are calculated using an anti-entropy weighting method. The objective weights are coupled with the initial weights obtained from the AHP weighting method to obtain the comprehensive weight of the unit. The results of the comprehensive weight of the state variables are shown in Table 6.

TABLE 6
Statistics of Comprehensive Weight
Calculation Results for State Variables

| | | Initial | Objective | |
|---|---|---|---|---|
| | | weights | weights | |
| | | obtained | obtained | |
| | | from | from the | |
| | | the | anti- | |
| | | AHP | entropy | Compre- |
| Component | | weighting | weighting | hensive |
| level (B) | Index level (C) | method | method | weight |
| B1 Water | C1 Availability rate | 33.66% | 23.56% | 27.53% |
| pump | C2 Number of water | 24.43% | 27.63% | 25.36% |
| | level simulation out-of- | | | |
| | tolerance occurrences | | | |
| | C3 Pump start and stop | 17.89% | 19.78% | 18.35% |
| | abnormal action rate | | | |
| | C4 Water pump operation | 12.15% | 19.35% | 18.40% |
| | qualification rate | | | |
| | C5 Water pump pumping | 11.87% | 9.68% | 10.36% |
| | efficiency | | | |
| B2 PLC | C6 Availability rate | 25.00% | 41.38% | 35.22% |
| control | C7 Pump start and stop | 75.00% | 56.82% | 64.78% |
| component | abnormal action rate | | | |
| B3 Liquid | C8 Availability rate | 25.00% | 37.80% | 30.28% |
| level | C9 Number of water | | | |
| measurement | level simulation out-of- | 75.00% | 62.20% | 69.72% |
| component | tolerance occurrences | | | |

### 3) System Scoring

Extract relevant monitoring point data from Jun. 21, 2021, to Jul. 21, 2021 from a database, summarize standard calculation methods and requirements for characteristic indexes, and calculate real-time monitored values of the relevant characteristic indexes according to the standard calculation methods. Score the characteristic indexes according to an established scoring method. The specific content is shown in Table 7.

TABLE 7
Statistics of Scores of Characteristic Indexes

| | Health reference | Health | Real-time | Index |
|---|---|---|---|---|
| Index level | value (σ) | threshold | monitored value | score |
| Availability rate | 87.76(3.47) | [77.35, 98.17] | 84.68 | 70.41 |
| Number of water level | 3.12(0.17) | [2.61, 3.63] | 3.23 | 78.43 |
| simulation out-of- | | | | |
| tolerance occurrences | | | | |
| Pump start and stop | 2.45(0.11) | [2.12, 2.78] | 2.51 | 81.82 |
| abnormal action rate | | | | |
| Water pump operation | 84.65(4.15) | [72.20, 97.10] | 91.54 | 100 |
| qualification rate | | | | |
| Water pump pumping | 77.45(2.39) | [70.28, 84.62] | 75.64 | 74.76 |
| efficiency | | | | |

Calculate scores for index levels, component levels and system levels level by level, and after summarizing the statistics, the scores for the levels are shown in Table 8.

TABLE 8
Statistics of Scores of Levels

| | | | Component | | | System | |
|---|---|---|---|---|---|---|---|
| Index level (C) | Score | Weight | level (B) | Score | Weight | level (A) | Score |
| C1 Availability rate | 70.41 | 27.53% | | | | Top cover | 78.67 |
| C2 Number of water level | 78.43 | 25.36% | | | | drainage | |
| simulation out-of- | | | | | | system | |
| tolerance occurrences | | | | | | | |
| C3 Pump start and stop | 81.82 | 18.35% | B1 Water | 80.43 | 53.896% | | |
| abnormal action rate | | | pump | | | | |
| C4 Water pump operation | 100 | 18.40% | | | | | |
| qualification rate | | | | | | | |
| C5 Water pump pumping | 74.76 | 10.36% | | | | | |
| efficiency | | | | | | | |
| C6 Availability rate | 70.41 | 35.22 | B2 PLC | 77.80 | 16.378% | | |
| C7 Pump start and stop | 81.82 | 64.78% | control | | | | |
| abnormal action rate | | | component | | | | |
| C8 Availability rate | 70.41 | 30.28% | B3 Liquid | 76.01 | 29.726% | | |
| C9 Number of water level | 78.43 | 69.72% | level | | | | |
| simulation out-of- | | | measurement | | | | |
| tolerance occurrences | | | component | | | | |

A statistical analysis result of the method of the present invention indicates that the health evaluation score of the top cover drainage system of Unit 1 of a power station from Jun. 21, 2021 to Jul. 21, 2021 was 78.67, which was in the state of “Attention” according to a state evaluation classification table.

Historical monitoring data of Unit 1 of the power station for 30 weeks after Jun. 21, 2021, was retrieved, health evaluation was conducted using the method of the present invention in one-week intervals, and a health degree curve was plotted. Health data from an original health management platform of the unit was also retrieved and processed on a percentage basis, and a health degree curve was plotted. The two curves were compared, and the results are shown in FIG. 5.

As can be seen from FIG. 5, the health degree curve under the original health management platform has large short-term fluctuations, and the overall change range is large, while short-term fluctuations of the health degree curve fitted by the method of the present invention are relatively small, the trend of increasing or decreasing is relatively more uniform, and the range of health changes falls within an actual data variation range of the original unit, and the trends are the same, indicating that the method of the present invention is feasible and effective, with evaluation results that are more aligned with reality.

It should be noted that the terms “comprise”, “include” or any other variant thereof herein are intended to cover non-exclusive inclusions, such that a process, method, article, or system that includes a list of elements not only includes those elements, but also includes other elements not expressly listed, or further includes elements inherent to the process, the method, the article, or the system, not excluding the existence of additional identical elements in the process, method, article, or system that includes the element.

The serial numbers in the embodiments of the present invention are only for description, and do not imply the merits of the embodiments. The use of terms such as “first”, “second”, and “third” does not indicate any order and can be interpreted as names.

Through the above description of the implementations, those skilled in the art can clearly understand that the above embodiment methods can be implemented through software combined with a necessary general hardware platform, and of course, they can also be implemented through hardware. However, in many cases, the former is the preferred implementation. Based on such understanding, the technical solutions of the present invention essentially, or the part contributing to the prior art, may be embodied in the form of a software product, The computer software product is stored in a storage medium (such as a ROM/RAM, a porcelain disk, and an optical disk), and includes a plurality of instructions for instructing a terminal device (which may be a mobile phone, a computer, a server, a network device, or the like) performs the methods described in the embodiments of the present invention.

The above embodiments are merely preferred technical solutions of the present invention and should not be regarded as limitations on the present invention. The embodiments in the present invention and features in the embodiments can be combined in any way without conflict. The scope of protection of the present invention should be defined by the technical solutions defined in the claims, and equivalent replacement solutions including the technical features defined in the technical solutions defined in the claims shall also belong to the scope of protection of the present invention. That is, equivalent replacement improvements within this scope also fall within the scope of protection of the present invention.

What is claimed is:

1. A comprehensive weighting health evaluation method for a top cover drainage system of a hydroelectric generating set, comprising the following steps:
step 1: acquiring initial weights of components;
step 2: acquiring a comprehensive weight of state variables;
step 3: establishing standard requirements and scoring criteria for the top cover drainage system, the components and the state variables;
step 4: obtaining corresponding scores of the state variables based on monitoring point data of monitored variables from equipment;
step 5: obtaining corresponding scores of the components based on the calculated scores of the state variables according to the comprehensive weight of the state variables;
step 6: obtaining a corresponding score of the top cover drainage system based on the calculated scores of the components according to a comprehensive weight of the components; and
step 7: obtaining a final health evaluation result based on the score of the top cover drainage system according to the scoring criteria.

2. The comprehensive weighting health evaluation method for a top cover drainage system of a hydroelectric generating set according to claim 1, wherein acquiring the initial weights of the components in step 1 comprises the following steps:
step 1.1, dividing different components of the top cover drainage system of the hydroelectric generating set according to a first preset rule, and establishing a component-level evaluation set, wherein the first preset rule is the National Standard GB/T 11805-2019;
step 1.2, scoring the component-level evaluation set to form a direct influence matrix;
step 1.3, normalizing the direct influence matrix to obtain a normalized direct influence matrix; and
step 1.4, calculating the normalized direct influence matrix to obtain a comprehensive influence matrix, and obtaining the corresponding initial weights of the components.

3. The comprehensive weighting health evaluation method for a top cover drainage system of a hydroelectric generating set according to claim 2, wherein step 1.3 specifically comprises the following steps:
normalizing the direct influence matrix according to a first preset formula and a second preset formula to obtain the normalized direct influence matrix;
$$the first preset formula being {H}_{ax var} = max ( {\sum }_{j = 1}^{n} {a}_{ij} ) ;$$
$$the second preset formula being N = {( \frac{{a}_{i j}}{{H}_{ar var}} )}_{n \times n} ;$$
wherein in the formulas, H_{ax var} represents the direct influence matrix, aᵢⱼ represents the components or the state variables in a scenario set, and N represents the normalized direct influence matrix.

4. The comprehensive weighting health evaluation method for a top cover drainage system of a hydroelectric generating set according to claim 2, wherein step 1.4 specifically comprises the following steps:
superimposing indirect influences of elements in the normalized influence matrix through a third preset formula to obtain the comprehensive influence matrix;
$$a third preset formula being T = {N ( I - N )}^{- 1} ;$$
wherein in the formula, N represents the normalized direct influence matrix, and T represents the comprehensive influence matrix;
according to a fourth preset formula, a fifth preset formula and a sixth preset formula, respectively obtaining influence degrees, influenced degrees and central degrees of influence factors, and calculating the initial weights through a seventh preset formula;
$$the fourth preset formula being {D}_{i} = {\sum }_{j = 1}^{n} {t}_{i j} , ( i = 1 , 2 , 3 , … , n )$$
wherein in the formula, tᵢⱼ represents a comprehensive influence value of a corresponding element on all other elements in each row;
$$the fifth preset formula being {C}_{i} = {\sum }_{j = 1}^{n} {t}_{j i} , ( i = 1 , 2 , 3 , … , n )$$
wherein in the formula, tⱼᵢ represents a comprehensive influence value of a corresponding element on all other elements in each column;
$$the sixth preset formula being {M}_{i} = {D}_{i} + {C}_{i} ;$$
wherein in the formula, Dᵢ represents the influence degree, and Cᵢ represents the influenced degree;
$$the seventh preset formula being {ω}_{i} = \frac{{M}_{i}}{{\sum }_{i = 1}^{n} {M}_{i}} ;$$
wherein in the formula, Mᵢ represents the central degree.

5. The comprehensive weighting health evaluation method for a top cover drainage system of a hydroelectric generating set according to claim 1, wherein acquiring the comprehensive weight of the state variables in step 2 comprises the following steps:
step 2.1, dividing different state variables of components in the component-level evaluation set according to a second preset rule, and establishing a state variable-level evaluation set, wherein the second preset rule is the National Standard GB/T 28570-2012;
step 2.2, scoring the state variable-level evaluation set to form a direct influence matrix;
step 2.3, normalizing the direct influence matrix to obtain a normalized direct influence matrix;
step 2.4, calculating the normalized direct influence matrix to obtain a comprehensive influence matrix, and obtaining corresponding initial weights of the state variables;
step 2.5, determining corresponding objective weights of the state variables of the components based on an anti-entropy weighting method; and
step 2.6, performing a coupling calculation to obtain the comprehensive weight according to the initial weights and the determined objective weights of the state variables.

6. The comprehensive weighting health evaluation method for a top cover drainage system of a hydroelectric generating set according to claim 1, wherein step 3 comprises the following steps:
step 3.1, determining evaluation contents of the components in an evaluation scope of the top cover drainage system, wherein the evaluation contents are related to the state variables, and the state variables of the components need to be determined;
step 3.2, determining score deduction criteria for the state variables, which include standard requirements and scoring standards, and sequentially deducting corresponding scores that meet conditions to obtain a final score, wherein a unified score range for the state variables is 0-100, with an initial score of 100, and the score deduction conditions are related to target variables of the state variables; and
step 3.3, determining the scoring criteria for the top cover drainage system.

7. The comprehensive weighting health evaluation method for a top cover drainage system of a hydroelectric generating set according to claim 1, wherein step 4 comprises the following steps:
step 4.1, obtaining the scores of the state variables according to an eighth preset formula;
$$the seventh preset formula being U = 100 - P .$$

8. Wherein in the formula, U represents the scores of the state variables, and P represents deducted scores of the state variables. The comprehensive weighting health evaluation method for a top cover drainage system of a hydroelectric generating set according to claim 1, wherein step 5 comprises the following steps:
step 5.1, obtaining the scores of the components according to a ninth preset formula;
$$the ninth preset formula being Q = {\sum }_{1}^{n} {θ}_{j} {U}_{j} ( i = 1 , 2 , 3 , … , n ) ;$$
wherein in the formula, Q represents the scores of the components, θⱼ represents the comprehensive weight of the state variables; and Uᵢ represents the scores of the state variables.

9. The comprehensive weighting health evaluation method for a top cover drainage system of a hydroelectric generating set according to claim 1, wherein step 6 comprises the following steps:
step 6.1, obtaining the score of the top cover drainage system according to a tenth preset formula;
$$the tenth preset formula being R = {\sum }_{1}^{n} {ω}_{i} {Q}_{i} ( i = 1 , 2 , 3 , … , n )$$
wherein in the formula, R represents the score of the top cover drainage system, ωᵢ represents the initial weights of the components; and Qᵢ represents the scores of the components.

10. A comprehensive weighting health evaluation system for a top cover drainage system of a hydroelectric generating set, comprising: an initial weighting module (10), a comprehensive weighting module (20), a criterion establishment module (30), a state variable scoring module (40), a component scoring module (50), a system scoring module (60) and a health evaluation module (70);
the initial weighting module (10), configured to acquire initial weights of components;
the comprehensive weighting module (20) configured to acquire a comprehensive weight of state variables;
the criterion establishment module (30), configured to establish standard requirements and scoring criteria for the top cover drainage system, the components and the state variables;
the state variable scoring module (40), configured to acquire scores of the state variables through monitoring point data and the scoring criteria for the state variables;
the component scoring module (50), configured to acquire scores of the components through the comprehensive weight of the state variables and the scores of the state variables;
the system scoring module (60), configured to acquire a score of the top cover drainage system through the initial weights of the components and the scores of the components; and
the health evaluation module (70), configured to acquire a final health evaluation result through the score of the top cover drainage system.
